(19) United States
(12) Patent Application Publication
(10) Pub. No.: US 2006/0079300 A1
(43) Pub. Date: Apr. 13, 2006

(54) Structure of an ornamental member of a faceplate of a mobile phone

(76) Inventor: Hsuan-Yu Lin, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/032,117

(22) Filed: Jan. 11, 2005

(30) Foreign Application Priority Data
Oct. 13, 2004 (TW) 093216237

(51) Int. Cl. H04M 1/00

(52) U.S. Cl. 455/575.1

(57) ABSTRACT

A mobile phone includes a faceplate, which has a transparent plate portion, and a holding tunnel next to an inner side of the transparent plate portion, and which is provided with an ornamental member inserted in the holding tunnel to face the transparent plate portion; the ornamental member includes a securing board, and several ornamental blocks made in various colors; the securing board has several holding cavities on an outer side thereof while the ornamental blocks are respectively located on the holding cavities; thus, the appearance of the faceplate can be changed by means of relocating the ornamental blocks.

### BACKGROUND OF THE INVENTION

1. Field of the Invention

The present invention relates to an ornamental member of a faceplate of a mobile phone, more particularly one, which includes several ornamental blocks capable of being relocated to change the appearance of the faceplate.

2. Brief Description of the Prior Art

Conventionally, users have to replace the faceplates or housings of their mobile phones so as to change the appearance of the mobile phones. Therefore, faceplates and housings in various colors are manufactured for each and every kind of mobile phones, and when people buy mobile phones, they usually buy additional faceplates and housings so that they can change the appearance of the mobile phones in the future.

However, such method isn't economical because manufacturers have to produce faceplates and housings in various colors for each and every kind of their mobile phones, and the users have to buy additional faceplates and housings. And, such method isn't convenient because the users have to carry additional faceplates or housings with them otherwise they can't change the appearance of their mobile phones at any place at any time.

### SUMMARY OF THE INVENTION

It is a main object of the invention to provide an improvement on structure of a faceplate to overcome the above disadvantage.

The faceplate has a transparent plate portion, and a holding tunnel next to an inner side of the transparent plate portion. Furthermore, the faceplate is provided with an ornamental member inserted in the holding tunnel to face the transparent plate portion. The ornamental member includes a securing board, and several ornamental blocks made in various colors. The securing board has several holding cavities on an outer side thereof while the ornamental blocks are respectively located on the holding cavities; thus, the appearance of the faceplate can be changed by means of relocating the ornamental blocks.

### BRIEF DESCRIPTION OF THE DRAWINGS

The present invention will be better understood by referring to the accompanying drawings, wherein:

FIG. 1 is an exploded perspective view of the first embodiment according to the present invention,

FIG. 2 is an exploded perspective view of the second embodiment according to the present invention, and

FIG. 3 is a partial sectional view of the second embodiment.

### DETAILED DESCRIPTION OF THE PREFERRED EMBODIMENTS

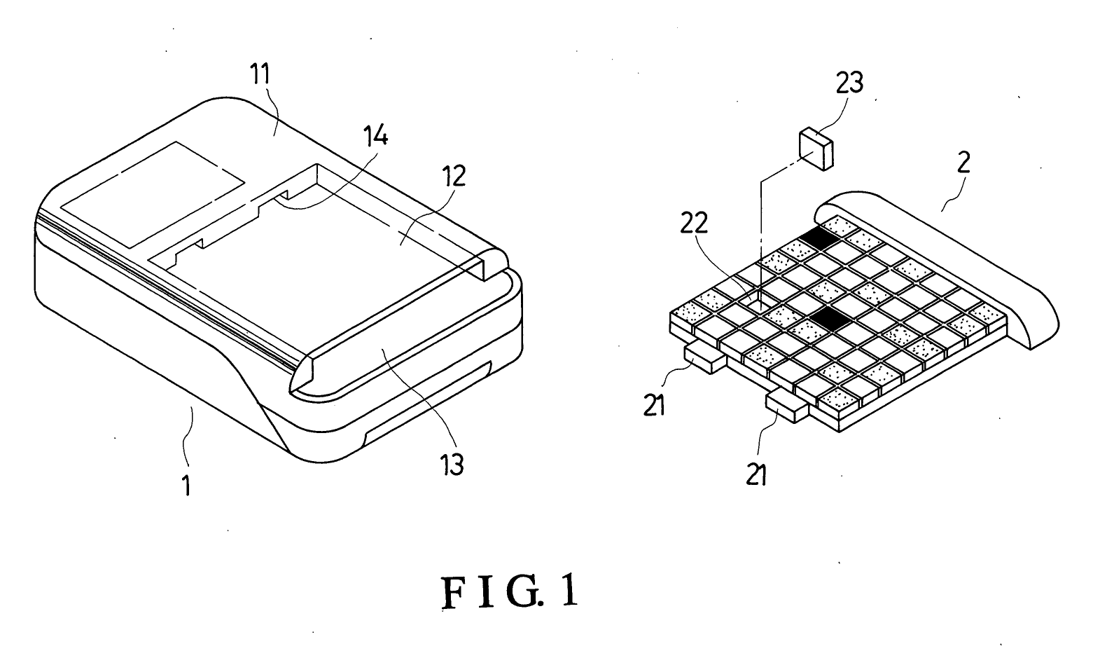

Referring to FIG. 1, a mobile phone 1 includes a faceplate 11, which has a transparent plate portion 12, a holding tunnel 13 next to an inner side of the transparent plate portion 12, and two engaging holes 14 next to an inner end of the holding tunnel 13.

Furthermore, the faceplate 11 is provided with an ornamental member, which includes a securing board 2, and several ornamental blocks 23. The securing board 2 has two engaging protrusions 21 at an inner end, and several holding cavities 22 on an outer side thereof. The ornamental blocks 23 are made in various colors, and they have such a shape as to be capable of being tightly held in the holding cavities 22 of the securing board 2. After the ornamental blocks 23 are respectively located in the holding cavities 22 of the securing board 2, the ornamental member is inserted in the holding tunnel 13 with the engaging protrusions 21 being respectively passed into the engaging holes 14, and with the ornamental blocks 23 facing the transparent plate portion 12 of the faceplate 11.

Consequently, the user can relocate the ornamental blocks 23 to change the pattern on the ornamental member after having taken the ornamental member out of the holding tunnel 13.

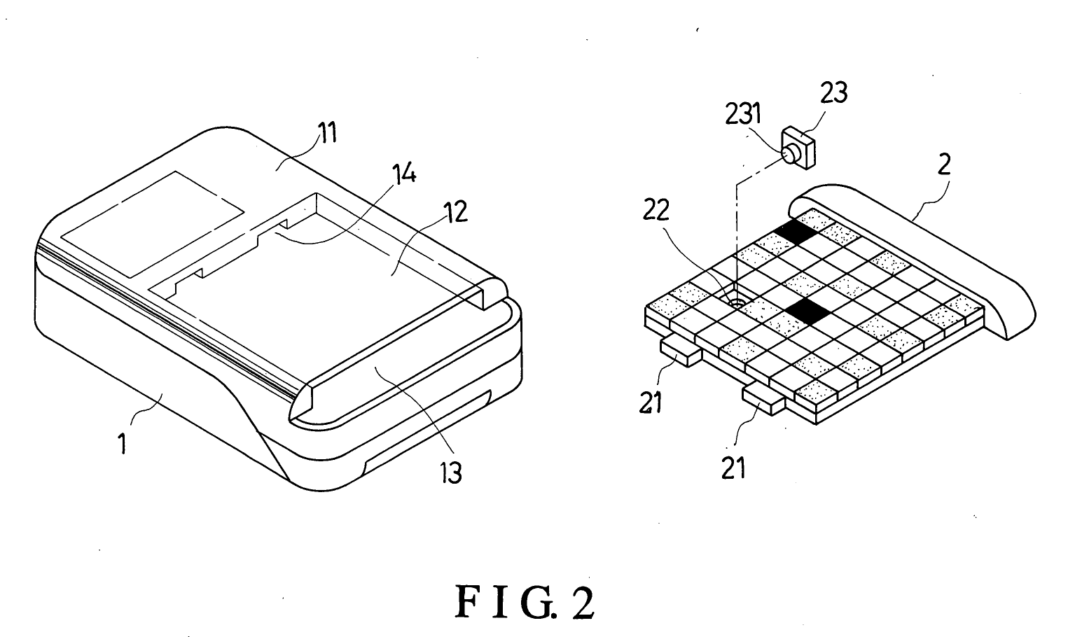

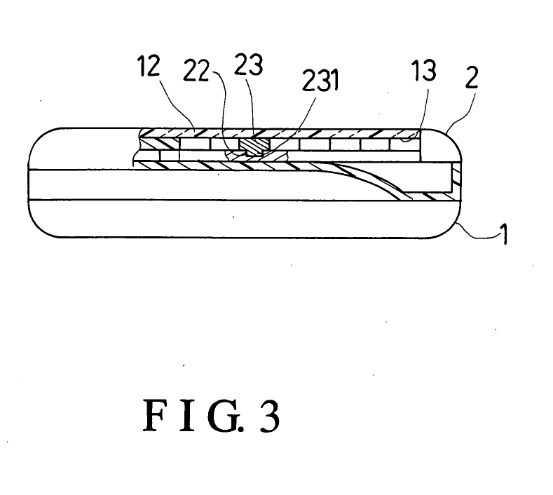

Referring to FIGS. 2 and 3, a second embodiment of an ornamental member includes a securing board 2, and several ornamental blocks 23. The securing board 2 has several holding cavities 22 on an outer side thereof. The ornamental blocks 23 are made in various colors, and each of the ornamental blocks 23 has an engaging stick portion 231. The engaging stick portions 231 have such a shape as to be capable of being tightly held in the holding cavities 22 of the securing board 2. Thus, the second embodiment has the same usage as the first one.

From the above description, it can be easily understood that the present invention has advantages as followings:

1. The ornamental member can be easily taken out of the holding tunnel, and the ornamental blocks can be easily relocated without use of any tool because the ornamental member is inserted in the holding tunnel, and because the ornamental blocks are held in the holding cavities of the securing board. Consequently, it is easy to change the pattern on the ornamental member.

2. To change the appearance of the faceplate, he user only has to relocate the ornamental blocks. Therefore, the user doesn't have to carry any other part for allowing him/her to change the appearance of the faceplate of the mobile phone.

What is claimed is:

1. Structure of an ornamental faceplate of a mobile phone,
the faceplate having a transparent plate portion, and a holding tunnel next to an inner side of the transparent plate portion;
the faceplate being equipped with an ornamental member inserted in the holding tunnel to face the transparent plate portion; the ornamental member including:
(a) a securing board having a plurality of holding cavities on an outer side thereof; and
(b) a plurality of groups of ornamental blocks respectively located on the holding cavities of the securing board; each ornamental block group being made in a respective color;
whereby appearance of the faceplate can be changed by means of relocating the ornamental blocks.

2. The structure as claimed in claim 1, wherein the faceplate has a plurality of engaging holes next to an inner end of the holding tunnel, and the securing board has a plurality of engaging protrusions at an inner end, which engaging protrusions will pass into respective ones of the engaging holes when the ornamental member is inserted in the holding tunnel.

3. The structure as claimed in claim 1, wherein the ornamental blocks have such a shape as to be capable of being tightly held in the holding cavities of the securing board.

4. The structure as claimed in claim 1, wherein each of the ornamental blocks has an engaging stick portion; the engaging stick portions having such a shape as to be capable of being tightly held in the holding cavities of the securing board.
